(19) United States
(12) Patent Application Publication
(10) Pub. No.: US 2016/0328966 A1
(43) Pub. Date: Nov. 10, 2016

(54) Motorist Comfort and Safety Aid for Use When Changing Tires

(71) Applicant: Jose E. Valentin, Rio Piedros, PR (US)

(72) Inventor: Jose E. Valentin, Rio Piedros, PR (US)

(21) Appl. No.: 14/704,873

(22) Filed: May 5, 2015

(51) Int. Cl. G08G 1/0955; B65D 25/28; B60Q 1/46

(52) U.S. Cl. CPC G08G 1/0955; B60Q 1/46; B65D 25/28

(57) ABSTRACT

The present invention relates to a device used to assist motorists when changing flat tires. More specifically the present invention relates to a pad for protecting the motorist's knee(s) while kneeling on the ground to change a flat tire and one or more integrally stowed, detachable high-intensity flashers that may be placed along the road behind the user as a warning to approaching motorists.

### CROSS-REFERENCE TO RELATED APPLICATIONS

This application takes benefit of U.S. Provisional Patent Application No. 61/992255, filed May 13, 2014, and hereby includes it in its entirety by reference.

### FIELD OF THE INVENTION

The present invention relates to devices used by motorists to change flat tires. More specifically the present invention relates to a pad for protecting the motorist's knee(s) while kneeling on the ground to change a flat tire and one or more integrally stowed, detachable high-intensity flashers that may be placed along the road behind the user as a warning to approaching motorists.

### BACKGROUND OF THE INVENTION

Changing a flat tire is one of the minor inconveniences that virtually all motorists encounter at least once. Ordinarily, the process includes elevating the flat tire by means of a jack, removing the nuts securing the wheel and tire to the brake rotor or drum, removing the wheel and flat tire, replacing the wheel and flat tire with a spare wheel and tire, mounting the spare wheel and tire to the brake rotor or drum, reaffixing the nuts, and lowering the car. Most of these processes are performed while kneeling or stooping on the ground with one (or two) knees in contact with the ground. Obviously, this is painful for many people.

Of course, flat tires occur at all times of the day or night. When changing a flat tire at night, or in reduced visibility situations such as rain or fog, safety is of paramount importance because a motorist might not be readily seen working in close proximity to the road. Because of this, many cars and trucks are equipped with warning reflectors for deployment by the motorist while changing the tire. Unsurprisingly, hurried motorists often forget to deploy them, and even when deployed, they function only if oncoming motorist's lights are on to illuminate them.

What is needed then is a pad for protecting the knee(s) of the motorist while changing a flat tire that incorporates at least one removable, remotely deployable high intensity flasher and optionally an additional high intensity flasher. Also, reflective tape and/or paint may be applied to the vertical edges of the pad to enhance the safety of the motorist.

Thus, it is a first goal of the present invention to provide a pad on which the motorist can support one or both knees while kneeling or stooping in the process of changing a flat tire. It is a second goal of the present invention to provide at least one removable high-intensity flasher stored integrally in the pad so that it may be retrieved and deployed along the roadside to warn approaching motorists that there is a stopped car ahead. It is a third goal of the present invention to provide a pad with reflective tape and/or paint on at least one vertical side to enhance user safety.

### SUMMARY OF THE INVENTION

The present invention comprises a rectilinear pad of rubber or some other elastic material with at least one molded knee depression shaped to accommodate the knee and anterior surface of the lower leg proximal to the knee. Molded or otherwise formed in the top surface of the pad is at least one storage depression. Mounted in each storage depression and retained there by means of friction is a battery powered high-intensity flasher. Such flashers are removed, activated, and deployed behind the motorist when in the act of changing a flat tire. In one embodiment, reflective tape and/or paint is affixed to at least one vertical side of the pad for enhanced user safety.

The present invention is used in the following manner: First, the pad is retrieved from the trunk or other storage location in the car or truck. Next, the motorist places the pad on the ground conveniently adjacent to the tire to be changed. Next, the motorist retrieves the high-intensity flasher from the storage depression on top of the pad, activates it, and places it on the ground some distance behind the rear of the car to warn other motorists that a car is stopped ahead. Next, the user returns to the pad, places a knee in the knee depression and proceeds to change the tire as customarily done. When done, the motorist retrieves the high intensity flasher, deactivates it, and replaces it in the storage depression on the top of the pad. Next, the motorist returns the pad to its storage location in the car or truck and continues his journey.

### BRIEF DESCRIPTION OF THE DRAWINGS

FIG. 1a comprises a first perspective view of one embodiment of a motorist comfort and safety aid for use when changing tires of the present invention.

FIG. 1b comprises a second perspective view of one embodiment of a motorist comfort and safety aid for use when changing tires of the present invention.

### DETAILED DESCRIPTION OF THE EMBODIMENTS

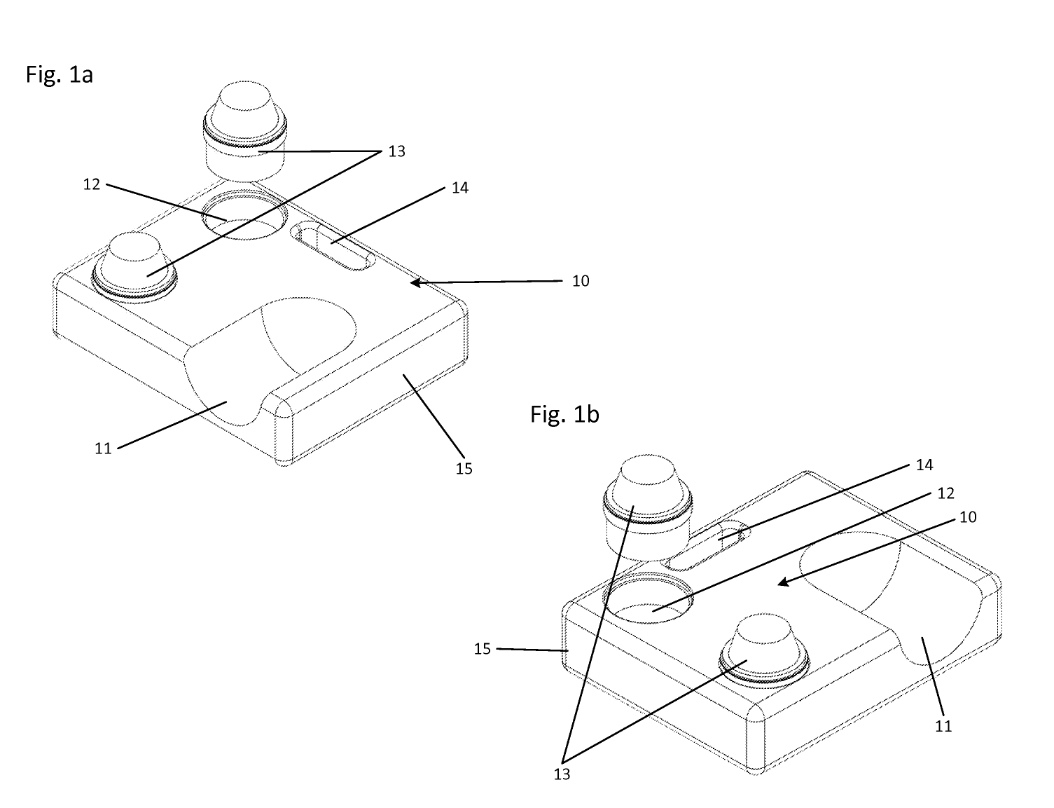

Referring now to FIGS. 1a and 1b, a first embodiment of a motorist comfort and safety aid 10 of the present invention is shown. In this form, the present invention comprises a generally rectilinear pad constructed of rubber or some similar elastic material. In one embodiment, the pad is composed of heat bonded rubber pellets made from recycled rubber road tires. It will be apparent however, that numerous other materials are eminently suitable. For example, dense polyurethane foam dipped in plastisol or “liquid vinyl” is also suitable. Many such equivalent fabrication materials and techniques are well known in the prior art and will not be not discussed further so as to not detract from the clarity of the present disclosure.

Motorist comfort and safety aid 10 is not limited to the depicted shape or size. To the contrary, the device can be made in virtually any shape or size. However, motorist comfort and safety aid 10 must be sufficiently thick to adequately protect the motorist's knees(s) when kneeling or stooping. Similarly, the depicted embodiment shows only one knee depression 11 shaped to accommodate the motorist's knee and the anterior surface of the lower leg proximal to the knee. It will be readily understood that other embodiments featuring two knee depressions are equally useful. Carrying handle 14 is shown as perforating motorist comfort and safety aid 10, but other types of handles are easily conceivable.

Molded or otherwise formed in the top surface of motorist comfort and safety aid 10 is at least one storage depression 12. Mounted in storage depression 12 and retained there by means of friction is a battery powered high-intensity flasher 13. High-intensity flasher 13 is well known in the prior art and commercially available in many shapes and forms. Of course, storage depression 12 can be shaped to accommodate high-intensity flasher 13 in any of these alternative shapes and forms. High-intensity flasher 13 generally comprises an LED or other light source, one or more batteries to provide power, and a switch and flashing circuit to flash the LED or other light source. It will be readily apparent that the switch may be any manually-operable type, but other configurations are readily conceivable, including, but not limited to, a spring-loaded switch in the external housing of high-intensity flasher 13 such that when high-intensity flasher 13 is placed in storage depression 12 the switch is open and when high-intensity flasher 13 is removed from storage depression 12 the switch is closed and the LED or other light source is activated. High-intensity flasher 13 includes a transparent or translucent cover to diffuse the light from the LED or other light source. Preferably the cover is molded of yellow or orange styrene plastic, but of course, any color and any type of moldable plastic may be selected.

In one embodiment, at least one of the vertical sides 15 of motorist comfort and safety aid 10 is covered with a reflective element. The reflective element is preferably 3M® Scotchlite® Reflective Striping Tape. Of course, the reflective element may be composed of any kind of reflective tape or paint, or a combination thereof.

The present invention is used in the following manner: First, motorist comfort and safety aid 10 is retrieved from the trunk or other storage location in the car or truck. Next, the motorist places motorist comfort and safety aid 10 on the ground conveniently adjacent to the tire to be changed. Next, the motorist retrieves high-intensity flasher 13 from storage depression 12 on top of motorist comfort and safety aid 10, activates it if necessary, and places it on the ground some distance behind the rear of the car to warn other motorists that a car is stopped ahead. Next, the user returns to motorist comfort and safety aid 10, places a knee in knee depression 11 and proceeds to change the tire (remove the damaged one and install the spare) in the customary manner. When done, the motorist retrieves high-intensity flasher 13, deactivates it if necessary, and replaces it in storage depression 12 on the top of motorist comfort and safety aid 10. Next, the motorist returns the motorist comfort and safety aid 10 to its usual storage location in the car or truck and continues his journey.

While the present invention has been described in what is thought to be the most useful variant, those skilled in the art will readily recognize that equivalent arrangements are easily constructed. All such variants that seek to alter: 1) The number of knee depressions 11; 2) The shape and configuration of carrying handle 14; and, 3) The general shape and thickness of motorist comfort and safety aid 10 are implicitly included in the spirit and scope of the present invention.

What is claimed is:

1. A motorist comfort and safety aid comprising:
a) a pad with at least one knee depression;
b) at least one storage depression formed in said pad; and
c) at least one high-intensity flasher removably stored in said storage depression.

2. A motorist comfort and safety aid of claim 1 further comprising a carrying handle.

3. A motorist comfort and safety aid of claim 1 further comprising at least one reflective element affixed to at least one vertical side of said pad.

4. A motorist comfort and safety aid of claim 1 comprised of heat bonded rubber pellets.

5. A motorist comfort and safety aid of claim 1 wherein said high-intensity flasher in activated and deactivated manually.

6. A motorist comfort and safety aid of claim 1 wherein said high-intensity flasher is activated when removed from said storage depression and deactivated when inserted into said storage depression.
